(19) United States
(12) Patent Application Publication
(10) Pub. No.: US 2017/0134634 A1
(43) Pub. Date: May 11, 2017

(54) PHOTOGRAPHING APPARATUS, METHOD OF CONTROLLING THE SAME, AND COMPUTER-READABLE RECORDING MEDIUM

(71) Applicant: SAMSUNG ELECTRONICS CO., LTD., Gyeonggi-do (KR)

(72) Inventors: Byoung-jae Jin, Gyeonggi-do (KR); Sang-jun Yu, Gyeonggi-do (KR)

(73) Assignee: Samsung Electronics Co., Ltd., Gyeonggi-do (KR)

(21) Appl. No.: 15/127,413

(22) PCT Filed: Nov. 18, 2014
(86) PCT No.: PCT/KR2014/011064

§ 371 Date: Sep. 19, 2016

(30) Foreign Application Priority Data
Mar. 19, 2014 (KR) 10-2014-0032297

(51) Int. Cl. H04N 5/235; H04N 5/232

(52) U.S. Cl. CPC H04N 5/2357; H04N 5/2353; H04N 5/23229

(57) ABSTRACT

A photographing apparatus includes: a photographing unit that captures a first image with a first exposure time that is set to the photographing apparatus and a second image with a second exposure time that is determined according to a flicker frequency of illumination; and an image processing unit that removes flicker by using the first image and the second image.

### TECHNICAL FIELD

One or more exemplary embodiments relate to a photographing apparatus, a method of controlling the photographing apparatus, and a computer-readable recording medium storing computer program codes executing the method of controlling the photographing apparatus.

### BACKGROUND ART

Photographing apparatuses generate an imaging signal by exposing an imaging device for an exposure time. The imaging device may be exposed for only the exposure time by a shutter. A global shutter system and a rolling shutter system are used in the photographing apparatuses.

The global shutter system resets an entire screen at the same time and starts exposure. The global shutter system causes no flicker, but needs a separate storage space in a sensor, leading to a degradation in efficiency and an increase in costs.

The rolling shutter system controls exposure in line units. The rolling shutter system needs no separate storage space in a sensor, but may cause a jello effect. That is, parallax may occur in upper and lower portions of a screen.

When a photographing apparatus captures a subject under an illumination using AC power, the brightness of the illumination changes with time. At this time, the frequency of the brightness of the illumination is proportional to the frequency of the AC power. For example, Korea uses AC power having a frequency of 1/60 second, and when a subject is photographed under an illumination using such AC power, the brightness of the illumination changes according to a frequency proportional to 1/60 second. In the case of the global shutter system that exposes the entire screen, the brightness of the entire screen changes due to the change in the brightness of the illumination. Therefore, in the case of the global shutter system, no flicker is found in the screen. On the contrary, in the case of the rolling shutter system, the brightness of the illumination does not uniformly change in the screen. For example, stripes may appear on the captured image according to the change in the brightness of the illumination. The phenomenon that the brightness of the screen is not uniform according to the change in the brightness of the illumination is referred to as a flicker.

If flicker occurs, the brightness of the captured image is different according to areas, thus degrading the quality of the captured image.

### DISCLOSURE OF INVENTION

### Solution to Problem

One or more exemplary embodiments are directed to remove flicker from a captured image, while freely changing an exposure time, in a photographing apparatus using a rolling shutter system.

One or more exemplary embodiments are directed to remove flicker from a captured image, while freely changing an exposure time, in a photographing apparatus using an electronic shutter of a rolling shutter system.

One or more exemplary embodiments make it possible to freely change an exposure time and capture an image in a manual mode in a photographing apparatus on which a small-sized photographing unit is mounted.

Additional aspects will be set forth in part in the description which follows and, in part, will be apparent from the description, or may be learned by practice of the presented exemplary embodiments.

According to one or more exemplary embodiments, a photographing apparatus includes: a photographing unit that captures a first image with a first exposure time that is set to the photographing apparatus and a second image with a second exposure time that is determined according to a flicker frequency of illumination; and an image processing unit that removes flicker by using the first image and the second image.

The second exposure time may be N/2f, where N is a natural number and f is a frequency of AC power for the illumination.

The photographing unit may capture the second image from a preview image.

The second image may be an image corresponding to a last frame of the preview image before the capturing of the first image.

A frame rate of the preview image may be determined according to the flicker frequency of the illumination.

When a shutter-release signal is input, the photographing unit may continuously capture the first image and the second image.

The photographing unit may operate in an electronic shutter system that controls exposure in line units.

The image processing unit may remove flicker by determining a correction gain by calculating a ratio of a pixel value of the first image to a pixel value of the second image and applying the determined correction gain to a pixel value of the first image.

Before determining the correction gain, the image processing unit may determine a first area where no flicker occurs in the first image by comparing the pixel value of the first image with the pixel value of the second image, calculate a difference of the pixel values of the first area between the first image and the second image, and remove an offset of the difference between the pixel values of the first image and the second image by applying the difference of the pixel values of the first area to at least one selected from the group consisting of the first image and the second image.

The image processing unit may determine the correction gain by calculating a ratio of the pixel values with respect to each color component and apply the correction gain to the pixel value of the first image with respect to each color component.

The image processing unit may remove the flicker with respect to each of blocks of the first image and the second image, and each of the blocks may include a plurality of pixel lines.

The image processing unit may remove the flicker with respect to each of pixels of the first image and the second image.

The image processing unit may perform a process of removing the flicker together with a process of correcting lens shading.

A resolution of the second image may be lower than a resolution of the first image.

The photographing unit may capture the first image in a manual mode, and the first exposure time may be set by a user.

The photographing unit may continuously capture a plurality of first images, and the image processing unit may remove flicker from the plurality of first images by using the single second image.

The image processing unit may determine whether a flicker has occurred by comparing the first image with the second image and perform a process of removing the flicker when it is determined that the flicker has occurred.

According to one or more exemplary embodiments, a method of controlling a photographing apparatus includes: capturing a first image with a first exposure time that is set to the photographing apparatus; capturing a second image with a second exposure time that is determined according to a flicker frequency of illumination; and removing flicker by using the first image and the second image.

The second exposure time may be N/2f, where N is a natural number and f is a frequency of AC power for the illumination.

The capturing the second image may include capturing the second image from a preview image.

The second image may be an image corresponding to a last frame of the preview image before the capturing of the first image.

A frame rate of the preview image may be determined according to the flicker frequency of the illumination.

The capturing of the first image and the capturing of the second image may be performed by continuously capturing the first image and the second image when a shutter-release signal is input.

The photographing apparatus may operate in an electronic shutter system that controls exposure in line units.

The removing of the flicker may include: determining a correction gain by calculating a ratio of a pixel values of the first image to a pixel value of the second image; and applying the determined correction gain to a pixel value of the first image to remove the flicker.

The removing of the flicker may further include, before the determining of the correction gain: determining a first area where no flicker occurs in the first image by comparing the pixel value of the first image with the pixel value of the second image; calculating a difference of the pixel values of the first area between the first image and the second image; and removing an offset of the difference between the pixel values of the first image and the second image by applying the difference of the pixel values of the first area to at least one selected from the group consisting of the first image and the second image.

The determining of the correction gain may include determining the correction gain by calculating a ratio of the pixel values with respect to each color component, and the removing of the flicker may include applying the correction gain to the pixel value of the first image with respect to each color component.

The removing of the flicker may be performed respect to each of blocks of the first image and the second image, and each of the blocks may include a plurality of pixel lines.

The removing of the flicker may be performed with respect to each of pixels of the first image and the second image.

The removing of the flicker may be performed together with a process of correcting lens shading.

A resolution of the second image may be lower than a resolution of the first image.

The capturing of the first image may be performed in a manual mode, and the first exposure time may be set by a user.

The capturing of the first image may include continuously capturing a plurality of first images, and the determining of whether the flicker has occurred and the removing of the flicker may be performed on the plurality of first images by using the single second image.

The method may further include determining whether a flicker has occurred by comparing the first image with the second image, and the removing of the flicker may be performed when it is determined that the flicker has occurred.

According to one or more exemplary embodiments, there is provided a computer-readable recording medium storing computer program codes that, when read and executed by a processor, cause the processor to perform the method of controlling the photographing apparatus.

### BRIEF DESCRIPTION OF DRAWINGS

These and/or other aspects will become apparent and more readily appreciated from the following description of the exemplary embodiments, taken in conjunction with the accompanying drawings in which:

FIG. 1 is a block diagram of a photographing apparatus according to an exemplary embodiment;

FIG. 2 is a diagram illustrating an image in which flicker occurs;

FIGS. 3 and 4 are diagrams describing how flicker occurs;

FIG. 5 is a flowchart of a process of removing flicker in an image processing unit, according to an exemplary embodiment;

FIG. 6 is a flowchart of a method of controlling a photographing apparatus, according to an exemplary embodiment;

FIG. 7 is a diagram of a method of capturing a first image and a second image, according to an exemplary embodiment;

FIG. 8 is a diagram of a method of capturing a first image and a second image, according to another exemplary embodiment;

FIG. 9 is a diagram describing a process of removing flicker, according to an exemplary embodiment;

FIG. 10 is a diagram illustrating a pixel value of a first image, a pixel value of a second image, and a correction gain with respect to each line, according to an exemplary embodiment;

FIG. 11 is a diagram describing a process of removing a correction offset between a first image and a second image, according to an exemplary embodiment;

FIG. 12 is a flowchart of a method of controlling a photographing apparatus, according to an exemplary embodiment;

FIG. 13 is a block diagram of an image processing unit according to another exemplary embodiment;

FIG. 14 is a flowchart of a method of controlling a photographing apparatus, according to an exemplary embodiment; and

FIG. 15 is a block diagram of a configuration of a photographing apparatus, according to an exemplary embodiment.

### MODE FOR THE INVENTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description.

The terms used herein will be described briefly and the exemplary embodiments will be then described in detail.

As the terms used herein, so far as possible, widely-used general terms are selected in consideration of functions; however, these terms may vary according to the intentions of those skilled in the art, the precedents, or the appearance of new technology. Also, in some cases, there may be terms that are optionally selected by the applicant, and the meanings thereof will be described in detail in the corresponding portions of the description of the exemplary embodiments. Therefore, the terms used herein are not simple terms and should be defined based on the meanings thereof and the overall description of the exemplary embodiments.

It will be understood that the terms “comprise”, “include”, and “have”, when used herein, specify the presence of stated elements, but do not preclude the presence or addition of other elements, unless otherwise defined. As used herein, the term “unit” refers to a software component or a hardware component such as FPGA or ASIC, and the “unit” performs certain tasks. However, the “unit” should not be construed as being limited to software or hardware. The “unit” may be configured to reside on an addressable storage medium and be configured to execute one or more processors. Therefore, the “unit” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “units” may be combined into fewer components and units or be further separated into additional components and “units”.

Exemplary embodiments will be described below in detail with reference to the accompanying drawings so that those of ordinary skill in the art may easily implement the exemplary embodiments. The exemplary embodiments may, however, be embodied in many different forms and should not be construed as being limited to the embodiments set forth herein. In addition, portions irrelevant to the description of the exemplary embodiments will be omitted in the drawings for a clear description of the exemplary embodiments, and like reference numerals will denote like elements throughout the specification.

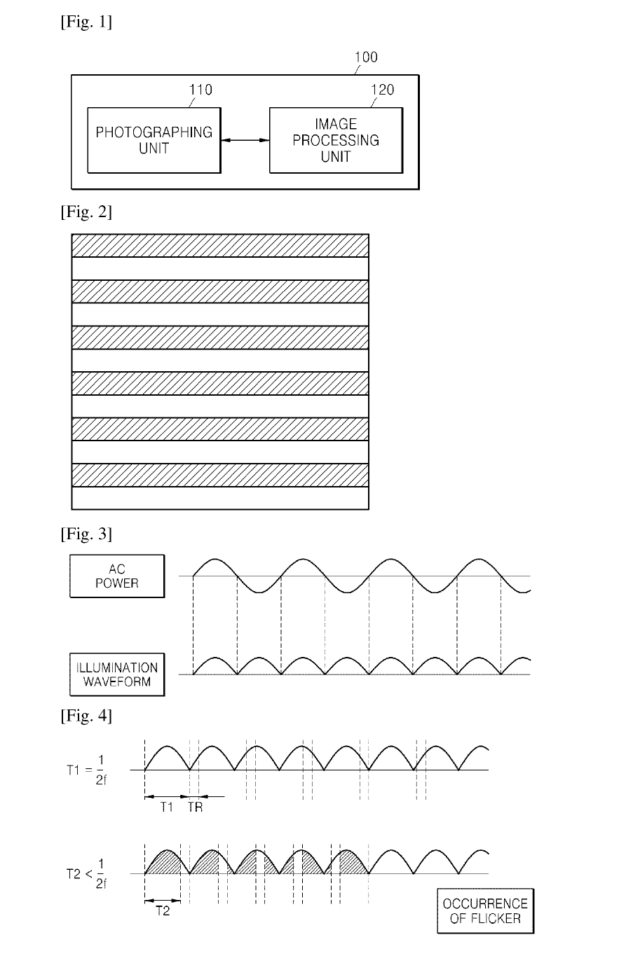

FIG. 1 is a block diagram of a photographing apparatus 100 according to an exemplary embodiment.

The photographing apparatus 100 according to the present exemplary embodiment may include a photographing unit 110 and an image processing unit 120.

The photographing apparatus 100 may be implemented in various forms, such as a camera, a mobile phone, a smartphone, a tablet personal computer (PC), a notebook computer, and a camcorder.

The photographing unit 110 may include a lens, an aperture, an imaging device, and the like. The photographing unit 110 may condense incident light and perform photoelectric conversion to generate an imaging signal. According to an embodiment, the photographing unit 110 may capture a first image with a first exposure time that is set to the photographing apparatus 100 and capture a second image with a second exposure time that is determined according to a flicker frequency of illumination. The capturing order of the first image and the second image may be variously determined according to embodiments.

The image processing unit 120 may remove flicker by using the first image and the second image. The image processing unit 120 may remove flicker from the first image. The image processing unit 120 may additionally perform image processing, such as noise removal, interpolation, lens shading correction, and distortion correction, on the first image, generate an image file storing the processed first image, and store the image file in a storage (not illustrated).

According to an embodiment, the photographing unit 110 may use a rolling shutter system.

According to an embodiment, the photographing unit 110 may include a focal-plane shutter using a front curtain and a rear curtain. The focal-plane shutter may adjust an exposure time by adjusting a time difference between the running start of the front curtain and the running start of the rear curtain. According to an embodiment, the photographing unit 110 may capture the first image with the first exposure time and the second image with the second exposure time by adjusting the time difference of the front curtain and the rear curtain.

According to another exemplary embodiment, the photographing unit 110 may use an electronic shutter of a rolling shutter system. The electronic shutter of the rolling shutter system according to the present exemplary embodiment may repeat a reset operation, an exposure operation, and a readout operation with respect to each line.

FIG. 2 is a diagram illustrating an image in which flicker occurs.

In a case where the photographing unit 110 uses the rolling shutter system, flicker may occur in the captured image, as illustrated in FIG. 2. When the flicker occurs, stripes may appear in the captured image, as illustrated in FIG. 2.

FIGS. 3 and 4 are diagrams describing how the flicker occurs.

As illustrated in FIG. 3, AC power may have a sinusoidal waveform with a predetermined frequency. For example, Korea uses AC power having a frequency of 60 Hz, and Japan uses AC power having a frequency of 50 Hz.

Illumination, which operates with such AC power, has twice the frequency of the AC power. The illumination uses rectified AC power. In a case where AC power is full-wave rectified, an illumination waveform is output as illustrated in FIG. 3. This waveform is reflected as a change of brightness under light that is output from the illumination.

Under such illumination, when the exposure time is set to N/2f (where N is a natural number and f is a frequency of AC power), no flicker occurs in the captured image. As illustrated in FIG. 4, when the exposure time T1 is set to ½f, lines of the imaging device are respectively exposed during one period of illumination flicker. Thus, no flicker occurs because integral values of light intensity of the illumination are equal to one another in the respective lines. As illustrated in FIG. 4, even when a readout period TR intervenes between exposure periods of the lines, respectively, no flicker occurs in the captured image because the exposure time of each line is always ½f.

However, when the exposure time is set to a value other than N/2f, flicker may occur in the captured image. For example, as illustrated in FIG. 4, when the exposure time T2 is set to less than ½f, flicker occurs in the captured image because integral values of light intensity of the illumination are different from one another in the lines, respectively. Such a discomfort often occurs in the electronic shutter of the rolling shutter system. According to the exemplary embodiments, flicker occurring in the first image captured with the first exposure time, which is an arbitrary exposure time, is removed by using the second image captured with the second exposure time of N/2f.

The first exposure time may be set by a user, or may be automatically set by the photographing apparatus 100. When an image is captured in a manual mode, the user may directly set the first exposure time, or may indirectly set the first exposure time by adjusting an aperture value, a brightness value, and the like. When an image is captured in an automatic mode, a controller (not illustrated) or the like of the photographing apparatus 100 may set the first exposure time according to ambient brightness, a photographing mode set by the user, a photographing setting value set by the user, and the like. The first exposure time may be determined regardless of the flicker frequency of the illumination, which is determined according to the frequency of the AC power.

The second exposure time may be determined according to the flicker frequency of the illumination. According to an embodiment, the second exposure time is determined as N/2f.

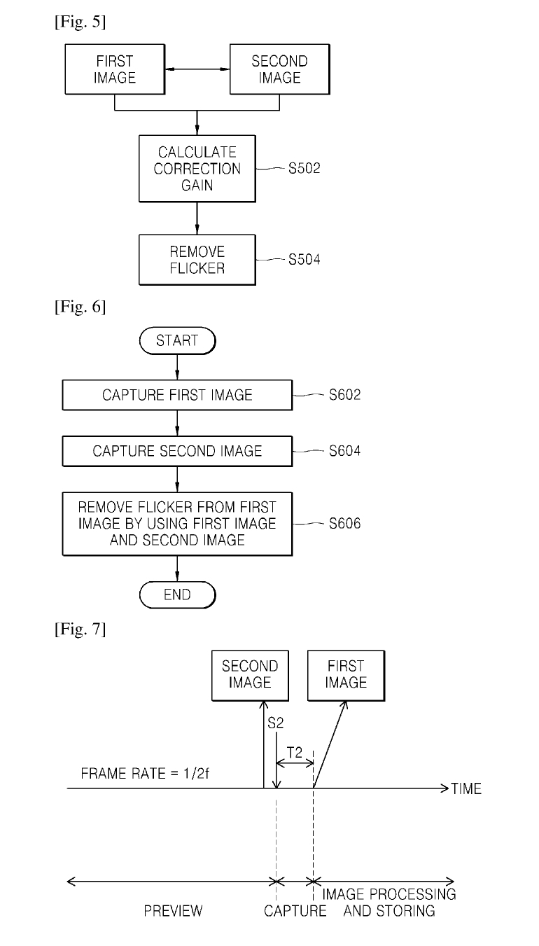

FIG. 5 is a flowchart of a process of removing flicker in the image processing unit 120, according to an exemplary embodiment.

When a first image and a second image are input, the image processing unit 120 calculates a correction gain for correcting flicker from the first image and the second image (S502).

According to an embodiment, the image processing unit 120 may calculate the correction gain by calculating a ratio of brightness values of the first image to those of the second image. In this case, the first image and the second image may be represented by a YCbCr format and a brightness value is a Y value. According to an embodiment, the ratio of the brightness values of the first image to those of the second image and the correction gain may be calculated with respect to each pixel. According to another exemplary embodiment, the ratio of the brightness values of the first image to those of the second image and the correction gain may be calculated with respect to each block.

According to another exemplary embodiment, the image processing unit 120 may calculate a correction gain of each of R, G, and B values by comparing R, G, and B values of the first image with R, G, and B values of the second image. A pixel value of each pixel of an image is defined by defining a red component value, a green component value, and a blue component value. The red component value, the green component value, and the blue component value are represented by R, G, and B, respectively. The comparison of the R, G, and B values and the calculation of the correction gain may be performed with respect to each pixel or each block according to embodiments.

The image processing unit 120 may remove flicker by using the correction gain (S504). According to an embodiment, the image processing unit 120 may remove flicker by multiplying the correction gain by each pixel or each block of the first image.

According to an embodiment, the correction gain may be multiplied by the brightness value (for example, the Y value of the YCbCr image) of each pixel of the first image.

According to another exemplary embodiment, the correction gain may be multiplied by the R, G, and B values of each pixel of the first image.

FIG. 6 is a flowchart of a method of controlling a photographing apparatus, according to an exemplary embodiment.

The photographing apparatus may capture a first image with a first exposure time and a second image with a second exposure time (S602 and S604). The capturing order of the first image and the second image is not limited to the example described with reference to FIG. 6, but may be variously determined according to embodiments. The first exposure time is an exposure time that is set to the photographing apparatus. The first exposure time may be directly or indirectly set by a user, or may be automatically set by the photographing apparatus. The second exposure time may be N/2f.

The photographing apparatus may remove flicker by using the first image and the second image (S606). For example, a correction gain for removing flicker may be calculated by using the first image and the second image, and flicker may be removed from the first image by multiplying the correction gain by each pixel of the first image.

FIG. 7 is a diagram of a method of capturing a first image and a second image, according to an exemplary embodiment.

According to an embodiment, when a shutter-release signal S2 is input in a preview mode and an image is captured, the second image may be an image corresponding to the last frame prior to the capturing of the first image among continuous frames of the preview mode. In addition, a frame rate of the preview mode may be determined according to a flicker frequency of illumination. According to an embodiment, the frame rate may be 2f/N. The last frame of the preview image may be temporarily stored in a main memory of the photographing apparatus and the image processing unit 120 may use the last frame of the preview image, which is temporarily stored in the main memory, as the second image.

Therefore, when the shutter-release signal S2 is input, the image processing unit 120 may capture the last frame of the preview image as the second image and capture the first image immediately after the second image is captured.

When the capturing of the first image is completed, the image processing unit 120 may remove flicker from the first image and generate an image file that stores the processed second image.

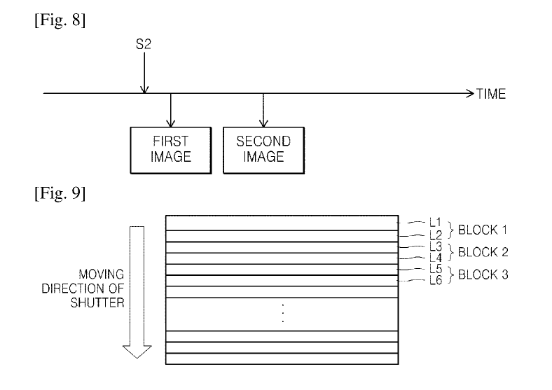

FIG. 8 is a diagram of a method of capturing a first image and a second image, according to another exemplary embodiment.

According to another exemplary embodiment, when a shutter-release signal S2 is input, the first image and the second image may be continuously captured. The first image may be captured with a first exposure time that is currently set to the photographing apparatus, and the second image may be captured with a second exposure time that is determined by a flicker frequency of illumination. The capturing order of the first image and the second image may be variously determined according to embodiments.

FIG. 9 is a diagram describing a process of removing flicker, according to an exemplary embodiment.

According to an embodiment, a correction gain may be calculated, and a process of removing flicker may be performed with respect to each block. The block may include one or more lines as illustrated in FIG. 9. As illustrated in FIG. 9, the lines may be lines L1, L2, L3, . . . , Ln that are arranged in a direction perpendicular to a moving direction of a rolling shutter. For example, as illustrated in FIG. 9, each of the blocks BLOCK1, BLOCK2 and BLOCK3 may include two lines. The number of lines included in each of the blocks BLOCK1, BLOCK2 and BLOCK3 may be changed according to embodiments.

According to the present exemplary embodiment, the image processing unit 120 may compare the first image with the second image with respect to each block. According to an embodiment, the image processing unit 120 may compare the first image with the second image with respect to each block by using an average value of pixel values of each block.

In the case of the rolling shutter, flicker may occur in a line form and flicker may substantially and similarly appear in the same line. Therefore, according to the present exemplary embodiment in which flicker removal is performed on each block including one or more lines, throughput for flicker removal may be reduced and excellent flicker removal performance may be obtained.

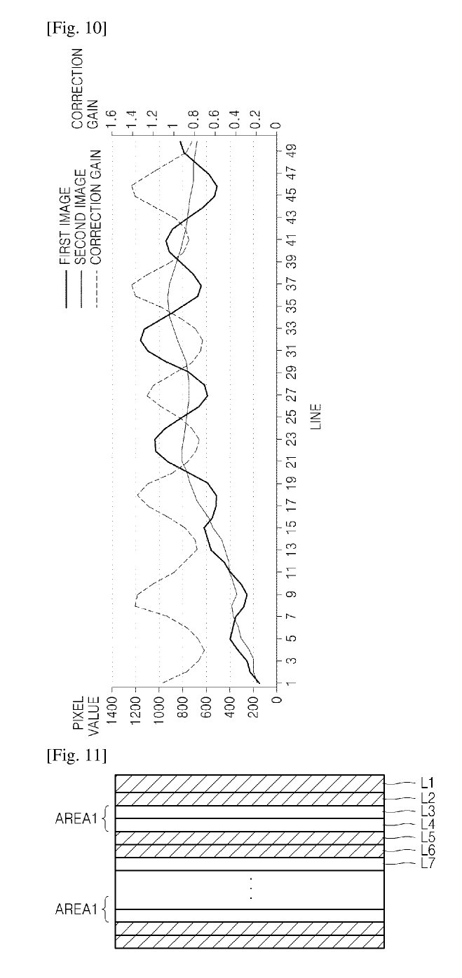

FIG. 10 is a diagram illustrating pixel values of a first image and a second image and a correction gains with respect to each line, according to an exemplary embodiment.

According to an embodiment, when the pixel values of the first image and the second image are compared with each other, a waveform due to flicker occurring in the first image may be output as illustrated in FIG. 10. Referring to the graph of FIG. 10, it is observed that the pixel value of the first image rises and falls with a predetermined frequency with respect to the pixel value of the second image. In this regard, when the pixel value of the second image is divided by the pixel value of the first image, a correction gain having a sinusoidal waveform with a predetermined frequency is calculated. Flicker may be removed from the first image by multiplying the correction gain by the pixel value of the first image.

According to an embodiment, the process of calculating the correction gain may be performed with respect to each block and the process of multiplying the correction gain by the pixel value of the first image may be performed with respect to each pixel.

According to another exemplary embodiment, the second image may have a lower resolution than that of the first image. In this case, according to an embodiment, after the resolution of the second image is increased, the first image may be compared with the second image. According to another exemplary embodiment, after a pixel corresponding to each pixel of the first image is found from the second image, the first image may be compared with the second image.

FIG. 11 is a diagram describing a process of removing a correction offset between a first image and a second image, according to an exemplary embodiment.

According to an embodiment, the image processing unit 120 may detect an area where no flicker occurs from the first image, calculate a correction offset between the first image and the second image from the area where no flicker occurs, remove the influence of the correction offset, and calculate the correction gain. For example, as illustrated in FIG. 11, when flicker occurs in lines L1 and L2, no flicker occurs in lines L3 and L4, and flicker occurs in lines L5 and L6, the correction offset may be calculated by using pixel values of the lines L3 and L4 where no flicker occurs.

The image processing unit 120 may extract an area where no flicker occurs by comparing the pixel value of the first image with the pixel value of the second image. For example, when a difference between the brightness value of the first image and the brightness value of the second image is equal to or less than a reference value, the image processing unit 120 may determine that no flicker occurs in the corresponding area.

The image processing unit 120 may calculate the correction offset by calculating a difference between the pixel value of the first image and the pixel value of the second image in the first area.

According to an embodiment, the correction offset may be calculated with respect to the entire image. That is, only one value may be calculated with respect to the entire first image. For example, the correction offset may be determined as an average value of differences between respective pixel values of the pixels of the first image.

According to another exemplary embodiment, the correction offset may be calculated with respect to each block. For example, the image processing unit 120 may use the correction offset, which is calculated in each block, in the first area, and may estimate the correction offset in areas other than the first area by using an interpolation method or the like.

According to another exemplary embodiment, the correction offset may be calculated with respect to each pixel. For example, the image processing unit 120 may define the correction offset, which is calculated in each block, as the correction offset of the first area, and may estimate the correction offset in areas other than the first area by using an interpolation method or the like.

According to an embodiment, the correction offset may be calculated by subtracting the pixel value of the first image from the pixel value of the second image in the first area.

After the correction offset is applied to each pixel of the first image or each pixel of the second image, the image processing unit 120 may calculate the correction gain by calculating a ratio of respective pixel values of the pixels of the first image. For example, the image processing unit 120 may calculate the correction gain by dividing the respective pixel values of the pixels of the second image by the respective pixel values of the pixels of the first image. According to an embodiment, the correction gain may be calculated with respect to each pixel.

According to another exemplary embodiment, the correction gain may be calculated with respect to each block. The block may include one or more lines. When the correction gain is calculated with respect to each block, the image processing unit 120 may calculate the correction gain with respect to each block by using the average value of the pixel values of the pixels included in each block.

According to an embodiment, the correction offset and the correction gain may be calculated with respect to each of R, G, and B values. In addition, the correction offset and the correction gain may be calculated with respect to each pixel. In this case, the flicker-corrected R, G, and B values may be calculated using Equations 1, 2 and 3 below.

R′(x,y)=R(x,y)*K1(x,y)+C1(x,y) (Equation 1)

G′(x,y)=G(x,y)*K2(x,y)+C2(x,y) (Equation 2)

B′(x,y)=B(x,y)*K3(x,y)+C3(x,y) (Equation 3)

R(x, y), G(x, y), and B(x, y) represent R, G, and B values before the flicker correction of each pixel (x, y), respectively, and R′(x, y), G′(x, y), and B′(x, y) represent R, G, and B values after the flicker correction of each pixel (x, y), respectively. K1(x, y), K2(x, y), and K3(x, y) represent the correction gains for R, G, and B of each pixel, respectively, and C1(x, y), C2(x, y), and C3(x, y) represent the correction offsets for R, G, and B of each pixel, respectively.

According to an embodiment, the correction offset and the correction gain may be calculated with respect to the brightness value. In addition, the correction offset and the correction gain may be calculated with respect to each pixel. When the first image and the second image are represented in a YCbCr format, the correction offset and the correction gain may be calculated with respect to a Y value. A flicker-corrected Y value may be calculated by using Equation 4 below.

Y′(x,y)=Y(x,y)*K4(x,y)+C4(x,y) (Equation 4)

Y(x, y) represents a Y value before the flicker correction of the pixel (x, y), and Y′(x, y) represents a Y value after the flicker correction of the pixel (x, y). K4(x, y) represents the correction gain for the Y value of each pixel, and C4(x, y) represents the correction offset for the Y value.

According to an embodiment, the correction offset and the correction gain may be calculated with respect to each of R, G, and B colors. In addition, the correction offset and the correction gain may be calculated with respect to each line, or may be calculated with respect to each block including a plurality of lines. For example, the correction gain and the correction offset of each line or each block with respect to R may be calculated by using an average value of R values of each line or each block. In a manner similar to R, the correction gain and the correction offset may be calculated with respect to G and B by using an average value of G and B values of each line or each block. According to the present exemplary embodiment, R, G, and B values corrected in each pixel may be calculated by using the correction gain and the correction offset calculated with respect to each line or each block. In this case, the flicker-corrected R, G, and B values may be calculated using Equations 5, 6, and 7 below.

R′(x,y)=R(x,y)*K1(y)+C1(y) (Equation 5)

G′(x,y)=G(x,y)*K2(y)+C2(y) (Equation 6)

B′(x,y)=B(x,y)*K3(y)+C3(y) (Equation 7)

R(x, y), G(x, y), and B(x, y) represent R, G, and B values before the flicker correction of each pixel (x, y), respectively, and R′(x, y), G′(x, y), and B′(x, y) represent R, G, and B values after the flicker correction of each pixel (x, y), respectively. K1(y), K2(y), and K3(y) represent the correction gains for R, G, and B of each line or each block, respectively, and C1(y), C2(y), and C3(y) represent the correction offsets for R, G, and B of each line or each block, respectively.

According to an embodiment, the correction offset and the correction gain may be calculated with respect to brightness value. In addition, the correction offset and the correction gain may be calculated with respect to each line, or may be calculated with respect to each block including a plurality of lines. For example, the correction gain and the correction offset of each line or each block may be calculated by using an average value of brightness values of each line or each block. When the first image and the second image are represented in a YCbCr format, the correction offset and the correction gain may be calculated with respect to a Y value. A flicker-corrected Y value may be calculated by using Equation 8 below.

Y′(x,y)=Y(x,y)*K4(y)+C4(y) (Equation 8)

Y(x, y) represents a Y value before the flicker correction of the pixel (x, y), and Y′(x, y) represents a Y value after the flicker correction of the pixel (x, y). K4(y) represents the correction gain for the Y value of each pixel, and C4(y) represents the correction offset for the Y value.

According to the present exemplary embodiment, after a difference between pixel values of an image, which is caused by a time difference in capture time between the first image and the second image, is compensated for by the correction offset, the correction gain is calculated and a variable due to the time difference between the first image and the second image may also be removed. Therefore, according to the present exemplary embodiment, it is possible to prevent data of the first image from being distorted during the flicker correction process.

According to an embodiment, in detecting the area where no flicker occurs, the image processing unit 120 may estimate the number of spots, which are generated by flicker in one frame, by using the frequency of the AC power and the readout frame rate, and then, use the number of spots to detect the area where no flicker occurs. For example, when it is unclear whether flicker has occurred in a predetermined area, it is possible to determine whether the flicker has occurred in the corresponding area, based on the estimated number of spots. When the estimated number of spots is five or six and the number of spots currently detected due to the flicker is four, it may be determined that the flicker has occurred in the area where the occurrence of the flicker is unclear. The number of spots may be calculated by using Equations 9, 10, and 11 below.

t1=N/2f (Equation 9)

t2=1/S (Equation 10)

Number of Stops=t2/t1=2f/(N*S) (Equation 11)

where N is a natural number, f is the frequency of AC power, and S is the number of readout frames per second.

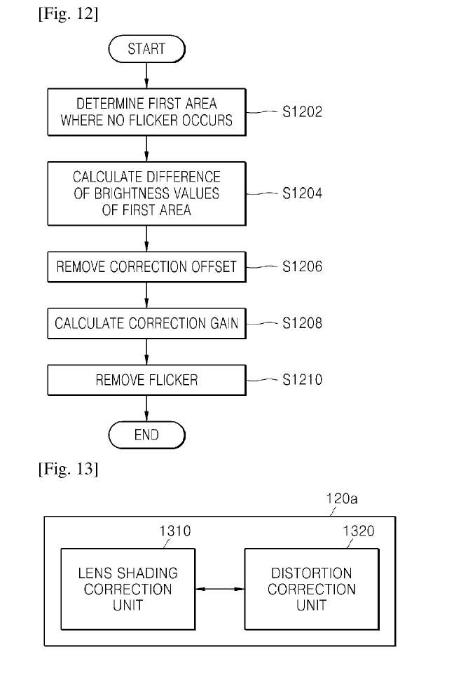

FIG. 12 is a flowchart of a method of controlling a photographing apparatus, according to an exemplary embodiment.

The method of controlling the photographing apparatus determines a first area where no flicker occurs from a first image (S1202). The first area where no flicker occurs may be determined by comparing a brightness value of the first image with a brightness value of a second image. For example, when a difference between the brightness value of the first image and the brightness value of the second image is equal to or less than a reference value, it may be determined that the first area is an area where no flicker occurs.

The method of controlling the photographing apparatus calculates a correction offset by calculating a difference between brightness values of the first area (S1204).

The method of controlling the photographing apparatus removes the correction offset from the first image and the second image (S1206). For example, the correction offset may be removed by subtracting the correction offset from the pixel value of each pixel of the first image and the pixel value of each pixel of the second image.

With respect to the first image and the second image from which the correction offset is removed, the method of controlling the photographing apparatus calculates a correction gain by calculating a ratio of pixel values of the first image to those of the second image (S1208). For example, the correction gain may be calculated by dividing the pixel value of the second image, from which the correction offset is removed, by the pixel value of the first image, from which the correction offset is removed.

As described above, the correction offset and the correction gain may be calculated with respect to each pixel or each block. In addition, as described above, the correction offset and the correction gain may be calculated with respect to a Y value in a YCbCr format, or may be calculated with respect to each of R, G, and B values in an RGB format.

The method of controlling the photographing apparatus removes flicker from the first image by using the correction offset and the correction gain (S1210). The process of removing the flicker may be performed by using Equations 1 to 8 as described above.

FIG. 13 is a block diagram of an image processing unit 120a according to another exemplary embodiment.

The image processing unit 120a may include a lens shading correction unit 1310 and a distortion correction unit 1320.

The lens shading correction unit 1310 corrects lens shading that is caused by a lens. The lens shading is that a circular brightness change occurs in a captured image. In the lens shading, the brightness at an edge portion of an image is reduced more than at a central portion thereof. The lens shading tends to become more serious when a diameter of a lens is decreased due to the downscaling of a camera module and an increase in a chief ray angle. In addition, the lens shading tends to become more serious as the resolution of a sensor is increased and a relative aperture (f-number) is increased. The lens shading correction unit 1310 corrects respective pixel values of the pixels of the first image and the second image so as to correct the lens shading. For example, the lens shading correction unit 1310 corrects a Y value in the first image and the second image, each of which is expressed in a YCbCr format.

The distortion correction unit 1320 corrects image distortion that is caused by a lens. In capturing an image, distortion may be caused by chromatic aberration of a lens. The distortion correction unit 1320 may correct lens distortion in a captured image by shifting each pixel of the captured image or adjusting a pixel value of each pixel.

According to an embodiment, the lens shading correction unit 1310 performs flicker correction together with lens shading correction. The lens shading correction unit 1310 may use a correction function of a lookup table or matrix form so as to correct the lens shading. At this time, by reflecting processing for flicker correction in the correction function, the lens shading correction unit 1310 may perform the lens shading correction and the flicker correction at the same time. For example, the lens shading correction unit 1310 may reflect both the correction offset and the correction gain in each variable of the matrix for the lens shading correction, and then, calculate a matrix product of the matrix and respective pixel values of the pixels of the first image.

According to another exemplary embodiment, the distortion correction unit 1320 performs the lens distortion correction and the flicker correction. When the distortion correction unit 1320 performs the process of shifting the pixels and the process of adjusting the pixel values of the respective pixels, the distortion correction unit 1320 may perform the process for the flicker correction together with the process of adjusting the pixel values of the pixels. For example, when the process of adjusting the respective pixel values of the pixels of the first image is performed by using the correction function of the lookup table or matrix form, the process for the flicker correction may be reflected in the correction function. For example, the distortion correction unit 1320 may reflect both the correction offset and the correction gain in each variable of the matrix for correcting the pixel values for the distortion correction, and then, calculate a product of the matrix and respective pixel values of the pixels of the first image.

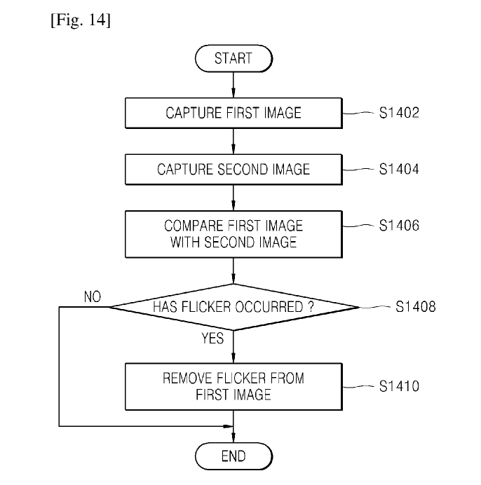

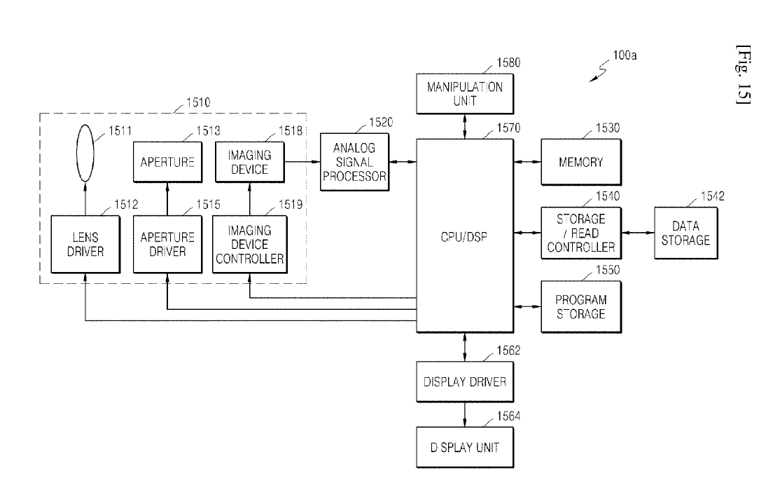

FIG. 14 is a flowchart of a method of controlling a photographing apparatus, according to an exemplary embodiment.

According to the present exemplary embodiment, the method of controlling the photographing apparatus captures a first image and a second image (S1402 and S1404), compares the first image with the second image (S1406), and determines whether flicker has occurred (S1408). The comparison between the first image and the second image may be performed by obtaining a difference image with respect to a Y value in a YCbCr format or by obtaining a difference image with respect to each of R, G, and B values in an RGB format. When a brightness value regularly changes in the difference image, for example, when regular stripes appear over the entire image as illustrated in FIG. 2, the method of controlling the photographing apparatus determines that flicker has occurred.

If it is determined that the flicker has occurred, the method of controlling the photographing apparatus performs a process of removing the flicker from the first image (S1410). Otherwise, if it is determined that no flicker has occurred, the process of removing the flicker is not performed.

According to another exemplary embodiment, the process of removing the flicker may or may not be performed according to a photographing mode of the photographing apparatus. For example, when the photographing mode of the photographing apparatus is an outdoor photographing mode, a landscape photographing mode, or a nightscape photographing mode, the process of removing the flicker may not be performed.

According to an embodiment, when the photographing mode of the photographing apparatus is a manual mode, the process of removing the flicker may be performed. According to another exemplary embodiment, when the photographing mode of the photographing apparatus is a manual mode, it may be determined whether flicker has occurred and the process of removing the flicker may be performed.

According to another exemplary embodiment, the process of removing the flicker may or may not be performed according to a white balance setting of the photographing apparatus. For example, the process of removing the flicker may be performed when the white balance of the photographing apparatus is set to fluorescent light, and the process of removing the flicker may not be performed when the white balance of the photographing apparatus is set to incandescent light or solar light.

According to an embodiment, when an image is captured in a continuous photographing mode, a plurality of first images may be continuously captured and a single second image may be captured. In this case, the process of removing flicker from the plurality of first images may be performed by using the single second image.

According to an embodiment, a process of correcting global motion occurring between the first image and the second image may be performed. In this case, after capturing the first image and the second image, the image processing unit 120 may perform a process of correcting the global motion before the process of removing the flicker. Global motion is that pixels of the first image and the second image are deviated from each other due to movement of the photographing apparatus between photographing viewpoints of the first image and the second image. According to the present exemplary embodiment, by performing the process of removing the flicker after the correction of the global motion, it is possible to minimize the image distortion occurring due to the process of removing the flicker and to more exactly remove the flicker.

Although the embodiments, in which the first image and the second image are defined by the R, G, and B values and the flicker correction is performed on the R, G, and B values, have been described above, respective pixel values of the first image and the second image may also be defined by a combination of color components other than the R, G, and B color components. In this case, the flicker correction may also be performed on the combination of the color components defining the respective pixels of the first image and the second image. For example, the correction offset and the correction gain may be calculated with respect to the combination of the color components that are different from R, G, and B color components.

FIG. 15 is a block diagram of the configuration of a photographing apparatus 100a, according to an exemplary embodiment.

The photographing apparatus 100a according to the exemplary embodiment may include a photographing unit 1510, an analog signal processor 1520, a memory 1530, a storage/read controller 1540, a data storage 1542, a program storage 1550, a display driver 1562, a display unit 1564, a central processing unit (CPU)/digital signal processor (DSP) 1570, and a manipulation unit 1580.

The overall operation of the photographing apparatus 100a is controlled by the CPU/DSP 1570. The CPU/DSP 1570 provides a lens driver 1512, an aperture driver 1515, and an imaging device controller 1519 with control signals for controlling operations of the lens driver 1512, the aperture driver 1515, and the imaging device controller 1519.

The photographing unit 1510 generates an image corresponding to an electric signal from incident light and includes a lens 1511, the lens driver 1512, an aperture 1513, the aperture driver 1515, an imaging device 1518, and the imaging device controller 1519.

The lens 1511 may include a plurality of lens groups, each of which includes a plurality of lenses. The position of the lens 1511 is adjusted by the lens driver 1512. The lens driver 1512 adjusts the position of the lens 1511 according to a control signal provided by the CPU/DSP 1570.

The degree of opening and closing of the aperture 1513 is adjusted by the aperture driver 1515. The aperture 1513 adjusts an amount of light incident on the imaging device 1518.

An optical signal that has passed through the lens 1511 and the aperture 1513 forms an image of a subject on a light-receiving surface of the imaging device 1518. The imaging device 1518 may be a charge-coupled device (CCD) image sensor or a complementary metal-oxide semiconductor image sensor (CIS) that converts an optical signal into an electric signal. The sensitivity and other factors of the imaging device 1518 may be adjusted by the imaging device controller 1519. The imaging device controller 1519 may control the imaging device 1518 according to a control signal automatically generated by an image signal input in real time or a control signal manually input by user manipulation.

The exposure time of the imaging device 1518 may be adjusted by a shutter (not illustrated). The shutter may be classified into a mechanical shutter that adjusts an amount of incident light by moving a position of a black screen or an electronic shutter that controls exposure by providing an electric signal to the imaging device 1518.

The analog signal processor 1520 performs noise reduction, gain control, waveform shaping, and analog-to-digital conversion on an analog signal provided from the imaging device 1518.

A signal processed by the analog signal processor 1520 may be input to the CPU/DSP 1570 directly or through the memory 1530. In this case, the memory 1530 operates as a main memory of the photographing apparatus 100a and temporarily stores information necessary when the CPU/DSP 1570 is operating. The program storage 1530 stores programs such as an operating system and an application system for running the photographing apparatus 100a.

In addition, the display unit 1564 displays an operating state of the photographing apparatus 100a or image information obtained by the photographing apparatus 100a. The display unit 1564 may provide visual information and/or auditory information to a user. In order to provide visual information, the display unit 1564 may include a liquid crystal display (LCD) panel or an organic light-emitting display (OLED) panel. In addition, the display unit 1564 may include a touch screen that can receive a touch input.

The display driver 1562 provides a driving signal to the display unit 1564.

The CPU/DSP 1570 processes an input image signal and controls components of the photographing apparatus 100a according to the processed image signal or an external input signal. The CPU/DSP 1570 may perform image signal processing on input image data, such as noise reduction, gamma correction, color filter array interpolation, color matrix, color correction, and color enhancement, in order to improve image quality. In addition, the CPU/DSP 1570 may compress image data obtained by the image signal processing into an image file, or may reconstruct the original image data from the image file. An image compression format may be reversible or irreversible. For example, a still image may be compressed into a Joint Photographic Experts Group (JPEG) format or a JPEG 2000 format. For recording of a moving image, a plurality of frames may be compressed into a moving image file according to Moving Picture Experts Group (MPEG) standards. For example, an image file may be created according to an exchangeable image file format (Exif).

Image data output from the CPU/DSP 1570 may be input to the storage/read controller 1540 directly or through the memory 1530. The storage/read controller 1540 stores the image data in the data storage 1542 automatically or according to a signal input by the user. In addition, the storage/read controller 1540 may read data related to an image from an image file stored in the data storage 1542 and input the data to the display driver 1562 through the memory 1530 or another path so as to display the image on the display unit 1564. The data storage 1542 may be detachably or permanently attached to the photographing apparatus 100a.

Furthermore, the CPU/DSP 1570 may perform sharpness processing, chromatic processing, blurring processing, edge emphasis processing, image interpretation processing, image recognition processing, image effect processing, and the like. The image recognition processing may include face recognition processing and scene recognition processing. In addition, the CPU/DSP 1570 may process a display image signal so as to display an image corresponding to the image signal on the display unit 1564. For example, the CPU/DSP 1570 may perform brightness level adjustment processing, color correction processing, contrast adjustment processing, edge enhancement processing, screen segmentation processing, character image generation processing, and image synthesis processing. The CPU/DSP 1570 may be connected to an external monitor to perform predetermined image signal processing so as to display the resulting image on the external monitor. The CPU/DSP 1570 may then transmit the image data obtained by the predetermined image signal processing to the external monitor so that the resulting image may be displayed on the external monitor.

The CPU/DSP 1570 may execute programs stored in the program storage 1530, or may include a separate module to generate control signals for controlling auto focusing, zooming, focusing, and automatic exposure compensation, to provide the control signals to the aperture driver 1515, the lens unit driver 1512, and the imaging device controller 1519 and to control overall operations of components included in the photographing apparatus 100a, such as a shutter and a strobe.

The manipulation unit 1580 allows a user to input control signals. The manipulation unit 1580 may include various function buttons, such as a shutter-release button for inputting a shutter-release signal that is used to take photographs by exposing the imaging device 1518 to light for a predetermined time, a power button for inputting a control signal in order to control the power on/off state of the photographing apparatus 100a, a zoom button for widening or narrowing an angle of view according to an input, a mode selection button, and other buttons for adjusting photographing settings. The manipulation unit 1580 may be implemented in any form, such as a button, a keyboard, a touch pad, a touch screen, or a remote controller, which allows a user to input control signals.

The photographing unit 110 of FIG. 1 may correspond to the photographing unit 1510 of FIG. 15. The image processing unit 120 of FIG. 1 may correspond to the CPU/DSP 1570 of FIG. 15.

The photographing apparatus 100a of FIG. 15 is merely an exemplary embodiment, and photographing apparatuses according to exemplary embodiments are not limited to the photographing apparatus 100a of FIG. 15.

As described above, according to the one or more of the above exemplary embodiments, it is possible to remove the flicker from the captured image, while freely changing the exposure time, in the photographing apparatus using the rolling shutter system.

Furthermore, it is possible to remove the flicker from the captured image, while freely changing the exposure time, in the photographing apparatus using the electronic shutter of the rolling shutter system.

Moreover, it is possible to freely change the exposure time and capture the image in the manual mode of the photographing apparatus on which a small-sized photographing unit is mounted.

In addition, other exemplary embodiments can also be implemented through computer-readable code/instructions in/on a medium, e.g., a computer-readable medium, to control at least one processing element to implement any above-described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A photographing apparatus comprising:
a photographing unit that captures a first image with a first exposure time that is set to the photographing apparatus and a second image with a second exposure time that is determined according to a flicker frequency of illumination; and
an image processing unit that removes flicker by using the first image and the second image.

2. The photographing apparatus of claim 1, wherein the second exposure time is N/2f, where N is a natural number and f is a frequency of AC power for the illumination.

3. The photographing apparatus of claim 1, wherein the photographing unit captures the second image from a preview image.

4. The photographing apparatus of claim 3, wherein the second image is an image corresponding to a last frame of the preview image before the capturing of the first image.

5. The photographing apparatus of claim 3, wherein a frame rate of the preview image is determined according to the flicker frequency of the illumination.

6. The photographing apparatus of claim 1, wherein when a shutter-release signal is input, the photographing unit continuously captures the first image and the second image.

7. The photographing apparatus of claim 1, wherein the photographing unit operates in an electronic shutter system that controls exposure in line units.

8. A method of controlling a photographing apparatus, the method comprising:
capturing a first image with a first exposure time that is set to the photographing apparatus;
capturing a second image with a second exposure time that is determined according to a flicker frequency of illumination; and
removing flicker by using the first image and the second image.

9. The method of claim 8, wherein the second exposure time is N/2f, where N is a natural number and f is a frequency of AC power for the illumination.

10. The method of claim 8, wherein the capturing the second image comprises capturing the second image from a preview image.

11. The method of claim 10, wherein the second image is an image corresponding to a last frame of the preview image before the capturing of the first image.

12. The method of claim 10, wherein a frame rate of the preview image is determined according to the flicker frequency of the illumination.

13. The method of claim 8, wherein the capturing of the first image and the capturing of the second image are performed by continuously capturing the first image and the second image when a shutter-release signal is input.

14. The method of claim 8, wherein the photographing apparatus operates in an electronic shutter system that controls exposure in line units.

15. A computer-readable recording medium storing computer program codes that, when read and executed by a processor, cause the processor to perform the method of controlling the photographing apparatus of claim 8.
